(19) United States
(12) Patent Application Publication
(10) Pub. No.: US 2013/0335998 A1
(43) Pub. Date: Dec. 19, 2013

(54) ELECTRONIC DEVICE AND METHOD OF GUIDING LIGHT IN THE SAME

(71) Applicants: Kazuya Inoue, Tokyo (JP); Yasushi Itou, Tokyo (JP); Takahisa Yamada, Tokyo (JP)

(72) Inventors: Kazuya Inoue, Tokyo (JP); Yasushi Itou, Tokyo (JP); Takahisa Yamada, Tokyo (JP)

(21) Appl. No.: 14/002,093

(22) PCT Filed: Mar. 15, 2011
(86) PCT No.: PCT/JP2011/056016

§ 371 Date: Aug. 28, 2013

(51) Int. Cl. F21V 8/00

(52) U.S. Cl. CPC G02B 6/002
USPC 362/606; 362/613; 362/612

(57) ABSTRACT

An electronic device is provided which is capable of reducing variations in the brightness of lights emitted from the light emitting parts. The electronic device has: a housing; a plurality of light sources provided within the housing, each light source emitting light along a light axis, the light axes of the light sources being directed in the same direction; and plurality of light guide plates provided within the housing, the light guide plates guiding the lights emitted from the light sources, respectively. Each light guide plate has a light incident plane on which the light emitted from the light source is incident and a light emitting part that is exposed at an outer surface of the housing. One of the light guide plates has a light incident plane angle that is different from the light incident plane angle of another light guide plate so that light axes of the lights that are guided within the light guide plates pass through the light emitting parts, wherein the light incident plane angle is an acute angle that is formed between the normal line of the light incident plane and the light axis of the light that is incident on the light incident plane.

### TECHNICAL FIELD

The present invention relates to an electronic device and a method of guiding light in an electronic device, more particularly to an arrangement for guiding lights emitted from light sources to indicators of a housing.

### BACKGROUND ART

An electronic device is provided with a plurality of luminous indicators that indicate operation state etc. to a user. As light sources for causing the indicators to emit lights, liquid crystals, organic EL elements, light-emitting diodes (LEDs) and the like are used. The indicators are provided on the top face, front face etc. of the electronic device.

The light sources that cause the indicators to emit lights may be provided in the vicinity of the indicators. However, particularly when a plurality of indicators are provided, arranging the plurality of light sources in the vicinity of the indicators may be restricted in relation to layout in the housing, facilitation of the assembling process etc. For this reason, a configuration may also be adopted in which the light sources are provided away from the indicators, from which lights are guided to the indicators via light guide plates. Patent document 1 discloses an art for guiding lights emitted from light sources to indicators via a plurality of light guide plates.

### PRIOR ART DOCUMENTS

### Patent documents

Patent document 1: JP2007-25017

### SUMMARY OF THE INVENTION

### Problems to be solved by the Invention

As explained above, the indicators are provided and exposed on the outer surface of the housing. In many cases, however, housings do not have strictly rectangular parallelepiped shapes. For electronic devices such as projectors, a rounded housing may often be employed on account of design. In such a housing, the relative positional relationship between the light sources and the indicators may vary according to the indicators, and it is likely that the amounts of lights that reach the indicators may vary from one indicator to another. As a result, brightness varies for each indicator and it becomes difficult to provide good visibility.

It is an object of the present invention to provide an electronic device, in which lights emitted from a plurality of light sources, provided within a housing, are guided through a plurality of light guide plates and are emitted from light emitting parts of the light guide plates, and which is capable of reducing variations in the brightness of lights emitted from the light emitting parts. It is another object of the present invention to provide a method of guiding lights, used for such an electronic device, which is capable of reducing variations in the brightness of lights emitted from the light emitting parts.

### Means to solve the Problems

According to one aspect of the present invention, the electronic device comprises: a housing; a plurality of light sources provided within the housing, each light source emitting light along a light axis, the light axes of the light sources being directed in a same direction; and plurality of light guide plates provided within the housing, the light guide plates guiding the lights emitted from the light sources, respectively. Each light guide plate comprises a light incident plane on which the light emitted from the light source is incident and a light emitting part that is exposed at an outer surface of the housing. One of the light guide plates has a light incident plane angle that is different from a light incident plane angle of another light guide plate so that light axes of the lights that are guided within the light guide plates pass through the light emitting parts, wherein the light incident plane angle is an acute angle that is formed between a normal line of the light incident plane and a light axis of the light that is incident on the light incident plane.

According to another aspect of the present invention, the method of guiding light in an electronic device comprises: emitting light from each of a plurality of light sources along a light axis, the light sources being provided within a housing, and the light axes of the light sources being directed in a same direction; and causing the lights emitted from the light sources to be incident on light incident planes of a plurality of light guide plates provided within the housing, guiding the lights within the light guide plates and causing the lights to be emitted from light emitting parts that are exposed at an outer surface of the housing. The lights emitted from the light sources are incident such that one of the light guide plates has a light incident plane angle that is different from a light incident plane angle of another light guide plate so that light axes of lights that are guided within the light guide plates pass through the light emitting parts, wherein the light incident plane angle is an acute angle that is formed between a normal line of the light incident plane and a light axis of the light that is incident on the light incident plane.

According to the present invention, the light incident plane angles are adjusted such that one of the light guide plates has a light incident plane angle that is different from a light incident plane angle of another light guide plate so that light axes of lights that are guided within the light guide plates pass through the light emitting parts. Accordingly, variations in the brightness of lights emitted from the light emitting parts can be reduced.

### Effects of the Invention

According to the present invention, it is possible to provide an electronic device, in which lights emitted from a plurality of light sources, provided within a housing, are guided through a plurality of light guide plates and emitted from light emitting parts of the light guide plates, which is capable of reducing variations in the brightness of lights emitted from the light emitting parts. According to the present invention, it is possible to provide a method of guiding lights, used for such an electronic device, which is capable of reducing variations in the brightness of lights emitted from the light emitting parts.

### BRIEF EXPLANATION OF THE DRAWINGS

FIG. 1 is a general perspective view of a projection-type display device according to an embodiment of the present invention;

FIG. 2 is an enlarged view in the vicinity of the indicators;

FIG. 3A is a top view of FIG. 2, as seen from line 3A-3A;

FIG. 3B is a side view of FIG. 2, as seen from line 3B-3B;

FIG. 4 is a partial top view of the interior of the device (the light guiding plates are not shown);

FIG. 5 is a partial top view of the interior of the device (the light guiding plates are shown);

FIG. 6 is a side view of the light source substrate and the light guide plates, as seen from line 6-6 in FIG. 5;

FIG. 7 is a cross-sectional view of the light guide plate;

FIG. 8 is a plan view of the light guide plate;

FIG. 9A is a cross-sectional view of the light guide plate, as seen from line A-A in FIG. 8;

FIG. 9B is a cross-sectional view of the light guide plate, as seen from line B-B in FIG. 8;

FIG. 9C is a cross-sectional view of the light guide plate, as seen from line C-C in FIG. 8; and

FIG. 9D is a cross-sectional view of the light guide plate, as seen from line D-D in FIG. 8.

### EXPLANATION OF NUMERALS

1 projection-type display device

2 housing

6 edge

8a-8d first to fourth indicators

11, 11a˜11d light guide plates

15 light incident plane

16 light emitting part

21 light source substrate

24, 24a˜24e first to fifth light sources

25, 26 light axis

θg total refraction angle

θi light incident plane angle (incident angle)

### MODE FOR CARRYING OUT THE INVENTION

An embodiment of the electronic device according to the present invention will now be explained by taking a projection-type display device as an example. The present invention may be applied to any kind of electronic devices as long as the devices have a mechanism in which lights emitted from a plurality of light sources, provided within a housing, are guided by a plurality of light guide plates and are emitted from light emitting parts of the light guide plates.

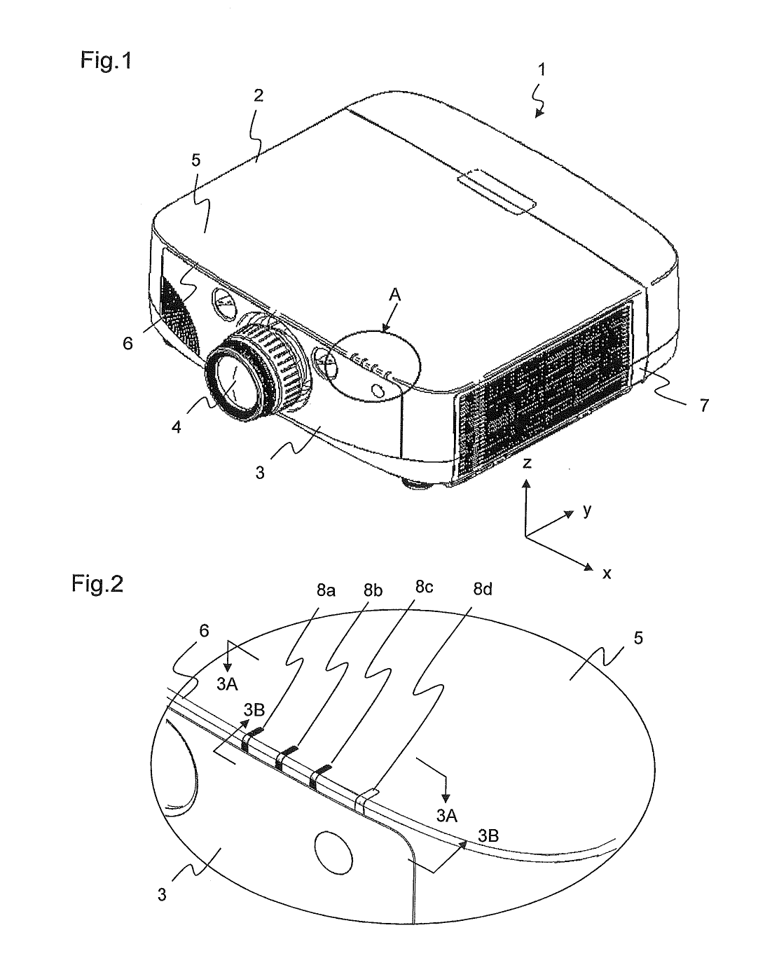

FIG. 1 is a general perspective view of a projection-type display device according to an embodiment of the present invention.

Projection-type display device 1 has housing 2 which has a generally rectangular parallelepiped shape whose faces are connected to each other by gentle curved lines. Projection lens 4 for projecting images is provided on front face 3. Edge 6 of housing 2, which defines the boundary between front face 3 and top face 5 of housing 2, is gradually lowered towards left and right side faces 7 of projection-type display device 1, and the more edge 6 approaches left and right side faces 7, the more edge 6 retreats backwards in projection-type display device 1. In other words, front face 3 of projection-type display device 1 has the highest point at the central region and is gradually lowered towards side faces 7, with the central region protruding most in the forward direction. The xyz- coordinates shown in the figures are defined such that the width direction and the height direction (the vertical direction) of projection-type display device 1, as seen from the front, correspond to x-direction and z-direction, respectively, and such that the depth direction of projection-type display device 1 that is orthogonal both to the x-direction and to the z-direction corresponds to y-direction.

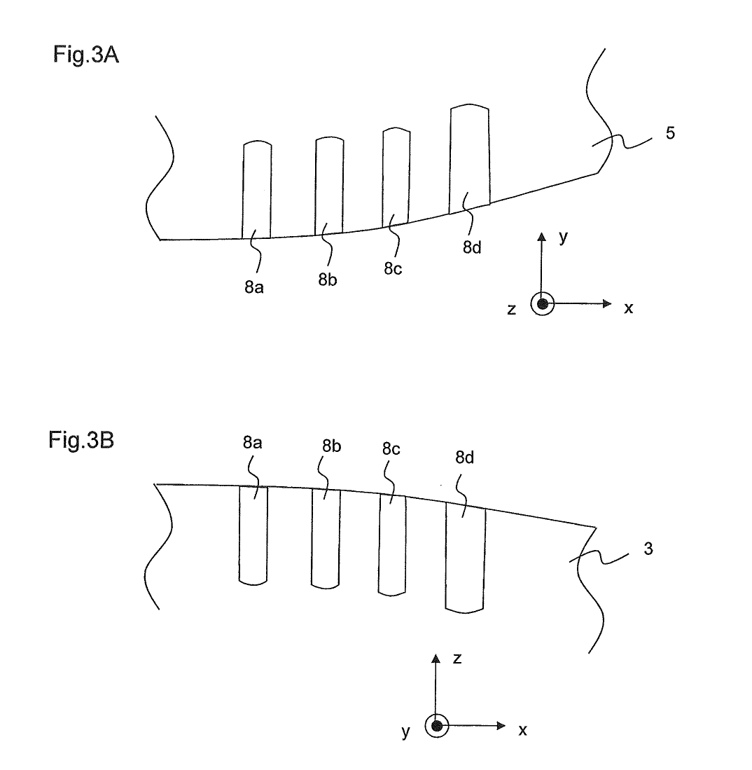

FIG. 2 is an enlarged view of portion A in FIG. 1, showing the details in the vicinity of the indicators. FIGS. 3A and 3B are a partial top view and a partial side view of the housing, as seen from line 3A-3A and line 3B-3B, respectively, conceptually showing the locations of the indicators. A plurality of indicators, four indicators (first to fourth indicators 8a-8d) in the embodiment, is arranged along edge 6 of housing 2. First to fourth indicators 8a-8d are constituted by light emitting parts 16 of light guide plates 11a to 11d, described later, and emit light to indicate the operation state of projection-type display device 1. Edge 6 of projection-type display device 1 has a three-dimensional curved line, with first to fourth indicators 8a to 8d located at positions different from each other both in the horizontal and vertical directions. In other words, first to fourth indicators 8a to 8d have y-coordinates (the depth direction) different from each other and z-coordinates (the vertical direction) different from each other. A part of or all of indicators 8a to 8d may have the same y-coordinate and/or the same z-coordinate. First to fourth indicators 8a to 8d extend across both sides of edge 6 so that first to fourth indicators 8a to 8d face front face 3 and top face 5 of housing 2. Accordingly, all of indicators 8a to 8d can be visually recognized both from top face 5 and front face 3 of projection-type display device 1.

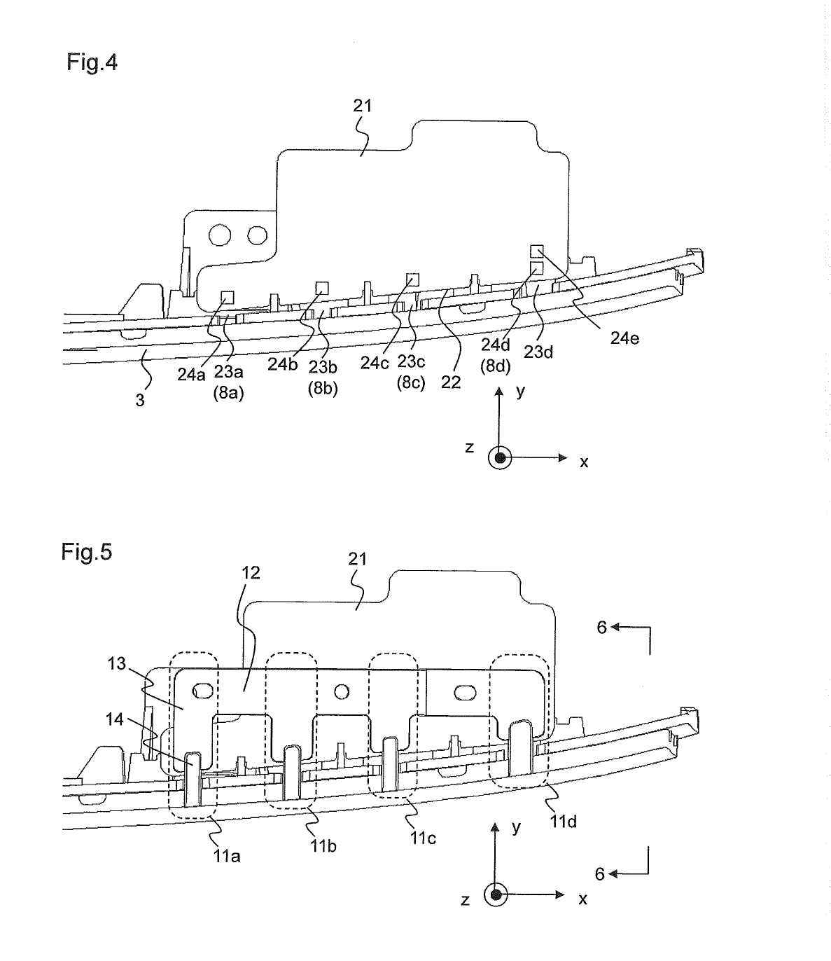

FIG. 4 is a partial top view of the projection-type display device. In FIG. 4, the light guide plates, described later, are omitted in order to illustrate the positional relationship between the light source substrate and the indicators. Light source substrate 21 is provided in the vicinity of the bottom face, not shown, of projection-type display device 1. Since front face 3 of housing 2 is curved, front edge 22 of light source substrate 21 is inclined relative to the x-axis. Housing 2 has openings 23a to 23d on which first to fourth indicators 8a to 8d are mounted, and openings 23a to 23d correspond to the locations of indicators 8a to 8d, respectively.

First to fifth light sources 24a to 24e are provided on light source substrate 21. First to third light sources 24a to 24c correspond to indicators 8a to 8c, respectively. Fourth and fifth light sources 24d and 24e correspond to fourth indicator 8d, having different y-coordinates and the same x-coordinate. Fourth indicator 8d may be used, for example, to indicate the ON/OFF state of the power source because it can emit brighter light than the other indicators 8a to 8c due to the lights coming from two light sources 24d and 24e. Light sources 24a to 24e may be, but are not limited to, surface emitting light emitting diodes. Light sources 24a to 24e may also be any kind of lighting means, such as liquid crystals, organic EL elements and the like.

Light source board 21 preferably may be a single board on which all of light sources 24a to 24e are mounted, but may be divided into two or more boards. Light source substrate 21 is placed substantially parallel to the bottom face of projection-type display device 1, that is, substantially horizontally within housing 2, so that light sources 24a to 24e have the same z-coordinate. Light sources 24a to 24e are mounted on light source board 21, with each light axis thereof being directed upwards in the vertical direction (y direction). The light axes may not be directed upwards in the vertical direction, but all of light sources 24a to 24e emit lights along light axes that are directed in the same direction.

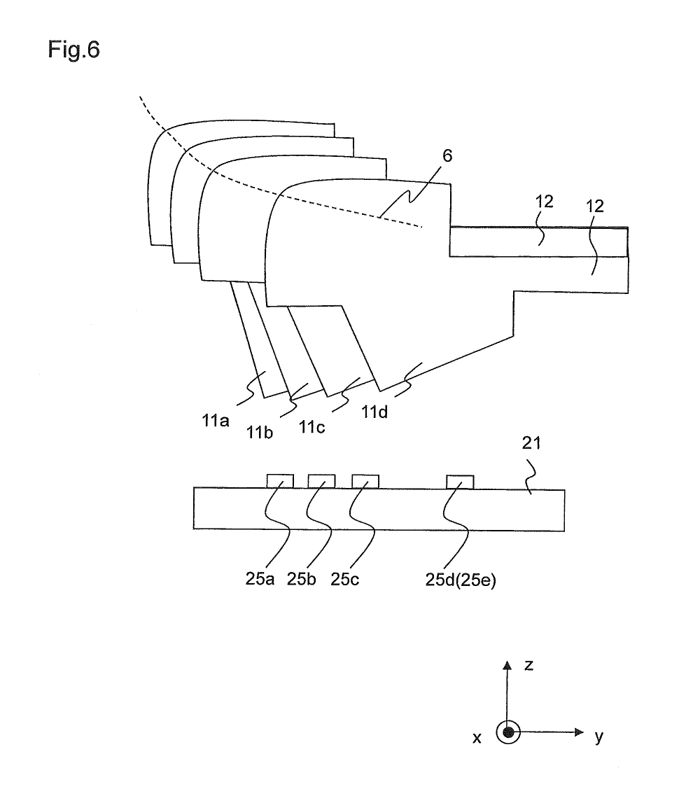

FIG. 5 is a view similar to FIG. 4, showing a partial top view of the projection-type display device. In addition to the light source substrate, the light guide plates are also shown in FIG. 5. FIG. 6 is a side view of the light source substrate and the light guide plates, as seen from line 6-6 in FIG. 5.

The light guide plates consist of first to fourth light guide plates 11a to 11d, each guiding light emitted from the light source. First to fourth light guide plates 11a to 11d are connected to each other by means of holding member 12. First to fourth light guide plates 11a to 11d are associated with indicators 8a to 8d, respectively. First to fourth light guide plates 11a to 11d, formed of polycarbonate, are fixed within housing 2 by means of holding member 12. In the present embodiment, holding member 12 is formed integrally with first to fourth light guide plates 11a to 11d, but it may be formed as a separate member. First light guide plate 11a is located closer to the central region of projection-type display device 1, and fourth guide plate 11d is located closer to side face 7 of projection-type display device 1. First light guide plate 11a is located nearest from projection lens 4 that is attached to front face 3 of projection-type display device 1, and the fourth light guide plate 11d is located farthest from projection lens 4.

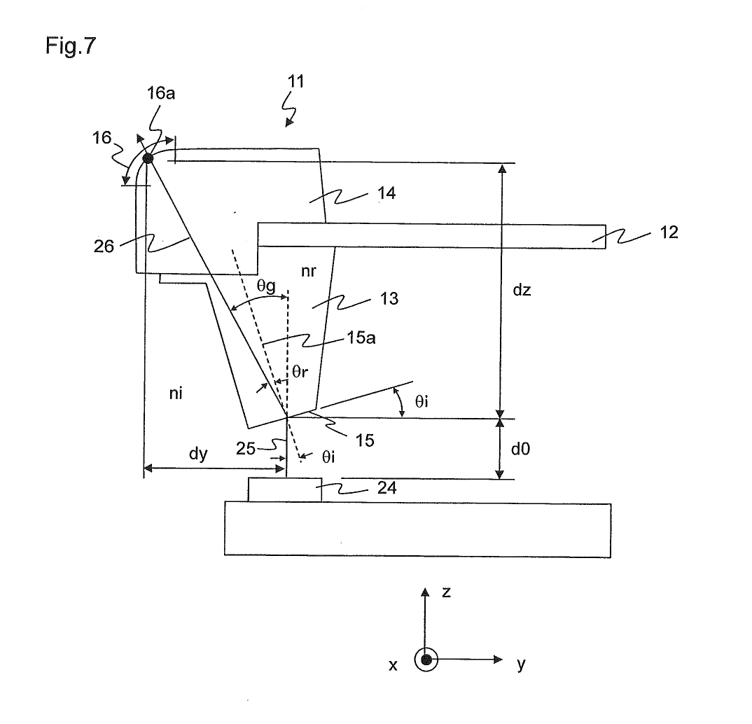

FIG. 7 is a cross-sectional view of the light guide plate. Since first to fourth light guide plates 11a to 11d have a common basic configuration, they are simply referred to as light guide plate 11 in the following explanation. Similarly, light sources 24a to 24e are simply referred to as light source 24. Light guide plate 11 has lower light guide plate 13 (see also FIG. 5) provided with light incident plane 15 on which light from light source 24 is incident and upper light guide plate 14 (see also FIG. 5) connected to lower light guide plate 13 and having light emitting part 16. Light emitting parts 16 of upper light guide plate 14 are exposed at the outer surface of housing 2 through openings 23a to 23d of housing 2, thus constituting respective indicators 8a to 8d. Light incident plane 15 of lower light guide plate 13 is formed as a plane that faces light source 24 that is formed on light source substrate 21, allowing light emitted from light source 24 to be incident on light incident plane 15.

FIG. 7 schematically illustrates the path of light which is emitted from light source 24, guided by light guide plate 11 and emitted from light emitting part 16. Light incident plane angle θi is defined as an acute angle that is formed between normal line 15a of light incident plane 15 and light axis 25 of the light that is incident on light incident plane 15. Light incident plane angle θi is equal to incident angle θi of light, defined at light incident plane 15, that is incident from light source 24. Light incident plane angle θi is set at an angle other than zero degree. Light that is incident on light incident plane 15 is refracted at refraction angle Or and changes the direction of travel. After changing the direction of travel, the light travels along a straight path through lower light guide plate 13 and upper light guide plate 14 to be emitted from light emitting part 16 of upper light guide plate 14, i.e., indicators 8a to 8d.

In the following explanation, total refraction angle θg is defined as an acute angle which is formed between light axis 25 of the incident light and light axis 26 of the light that is guided within light guide plate 11, wherein θg=θi+θr. Distance dz is defined as the distance between the z-coordinate of the point on light incident plane 15 on which light axis 25 of the incident light is incident and the z-coordinate of central portion 16a of light emitting part 16. Distance dy is defined as the distance between the y-coordinate of the point on light incident plane 15 on which light axis 25 of the incident light is incident and the y-coordinate of central portion 16a of light emitting part 16. Distance d0 is defined as the distance between the z-coordinate of the point on light incident plane 15 on which light axis 25 of the incident light is incident and the z-coordinate of the light emitting surface of light source 25. Distance d0 is the same for all of the light guide plates in the present embodiment, but may be different from each other.

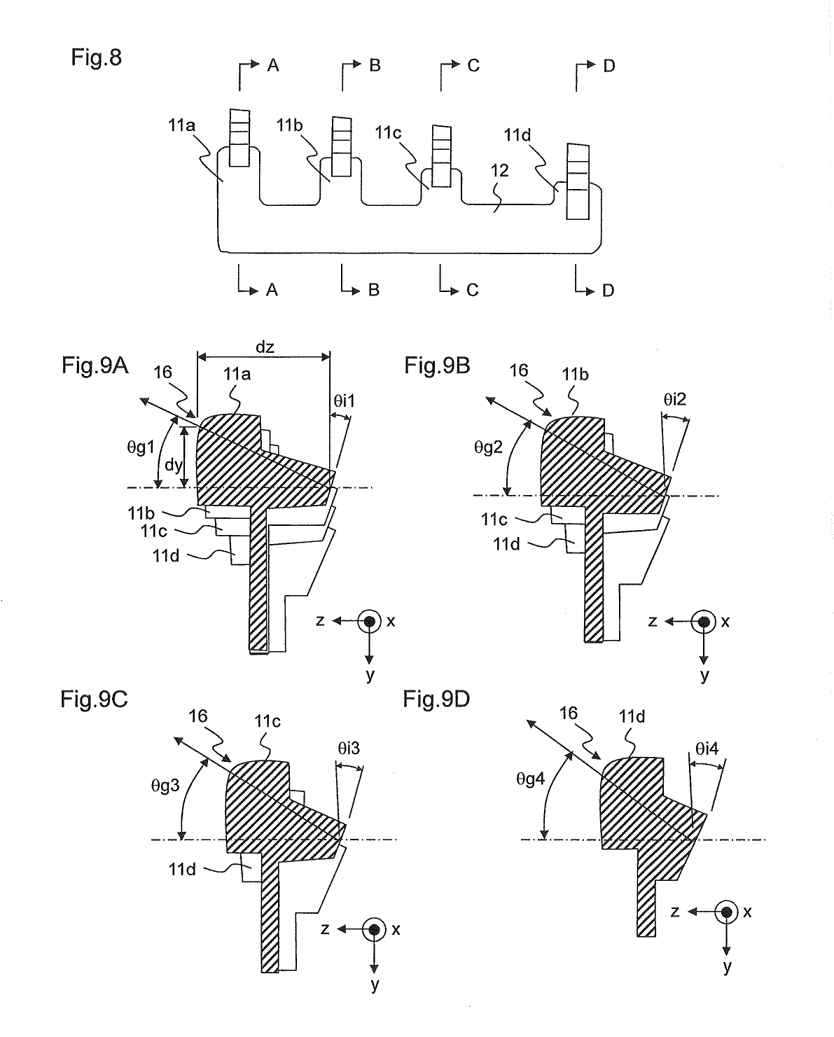

FIG. 8 is a plan view of light guide plate 11, and FIGS. 9A to 9D are cross-sectional views of light guide plate 11, as seen from lines A-A, B-B, C-C and D-D in FIG. 8, respectively. Since indicators 8a to 8d are arranged along edge 6, distance dz is the largest distance for first light guide plate 11a and the smallest distance for fourth light guide plate 11d. Thus, z-coordinates of first to fourth indicators 8a to 8d differ from each other. Meanwhile, since light sources 25a to 25e are provided on a single light source substrate 21 that is horizontally installed, the relative positional relationships in the z-direction among light sources 25a to 25e, light incident plane 15 of light guide plate 11 and light emitting parts 16 are different from each other for first to fourth light guide plates 11a to 11d. Distances dy are esssentially the same for first to fourth light guide plates 11a to 11d in the present embodiment, but distances dy in the y direction may also differ from each other according to the locations of the light sources. FIG. 6 shows edge 6 in the broken line that passes through indicators 8a to 8d.

Therefore, if first to fourth light guide plates 11a to 11d having the same shape are arranged in the same orientation, then the light that comes from a part of the light guide plates may not pass through the indicator, causing variations in brightness among the indicators. It is thus necessary to individually adjust the outputs of light sources 25a to 25e in order, for example, to cause first to third indicators 8a to 8c to emit light at the same brightness level and to cause fourth indicator 8d to emit light at a brightness level twice as large as the level for first to third indicators 8a to 8c.

For this reason, light incident plane angles θi in the present embodiment are different from each other for each light guide plate 11a to 11d so that light axes 26 of the lights that are guided by light guide plates 11a-11d pass through light emitting parts 16. As shown in FIGS. 9A to 9D, total refraction angle θg, which is formed between light axis 25 of the incident light and light axis 26 of the light that is guided within light guide plate 11, is defined as θg1, θg2, θg3, θg4 for first to fourth light guide plates 11a to 11d, respectively. Since light emitting part 16 of first light guide plate 11a protrudes most in the forward direction but is placed at the highest position, total refraction angle θg1 of first light guide plate 11a needs to be the smallest. On the other hand, since light emitting part 16 of fourth light guide plate 11d is placed at the rearmost and lowest position, total refraction angle θg4 of fourth light guide plate 11d needs to be the largest. In the present embodiment, the relationship: θg1<θg2<θg3<θg4 needs to be satisfied.

In order to satisfy this relationship, first to fourth light guide plates 11a to 11d are configured such that light incident plane angle θi satisfies the relationship: θi1<θi2<θi3<θi4, where θi1, θi2, θi3, and θi4 are light incident plane angles for first to fourth light guide plates 11a to 11d, respectively. By way of an example, first light incident plane angle θi1 is 14 degrees, second light incident plane angle θi2 is 16 degrees, third light incident plane angle θi3 is 18 degrees, and fourth light incident plane angle θi4 is 22 degrees.

It is generally preferable that the smaller the distance dz, the larger is light incident plane angle θi and that the larger the distance dy, the larger is light incident plane angle θi. More generally, it is preferable that the larger the total refraction angle θg, the larger is light incident plane angle θi, wherein total refraction angle θg is an acute angle that is formed between light axis 25 of the incident light and light axis 26 of the light that is guided within light guide plate 11. Thus, it is possible to cause the light that is incident on light incident plane 15 to be refracted at a predetermined refraction angle such that light axes 26 pass through indicators 8a to 8d and to cause indicators 8a to 8d to emit light at a uniform brightness level. Since light incident plane angle θi is determined by the relative positional relationship among light sources 25a to 25e, light incident planes 15 of light guide plates 11a to 11d and indicators 8a to 8d, light incident plane angles θi of all of light guide plates 11a to 11d may differ from each other or light incident plane angles θi of only a part of light guide plates 11a to 11d may differ from each other.

In order to determine light incident plane angles θi, total refraction angles θg for light guide plates 11a to 11d are first determined from the positions of light sources 25a to 25e, the positions of indicators 8a to 8d and so on. Light incident plane angles θi can be determined from the relationship θg=θi+θr and Snell's law (ni×sin θi=nr×sin θr, where ni is the refraction index of air, and nr is the refraction index of light guide plate 11).

What is claimed is:

1. An electronic device comprising:
a housing;
a plurality of light sources provided within the housing, each light source emitting light along a light axis; and
a plurality of light guide plates provided within the housing, the light guide plates guiding the lights emitted from the light sources, respectively,
wherein each light guide plate comprises a light incident plane on which the light emitted from the light source is incident and a light emitting part that is exposed at an outer surface of the housing; and
wherein one of the light guide plates has a light incident plane angle that is different from a light incident plane angle of another light guide plate so that light axes of the lights that are guided within the light guide plates pass through the light emitting parts, wherein the light incident plane angle is an acute angle that is formed between a normal line of the light incident plane and a light axis of the light that is incident on the light incident plane.

2. The electronic device according to claim 1, wherein the larger an acute angle, which is formed between the light axis of the light that is incident on the light incident plane and the light axis of the light that is guided within the light guide plate, the larger is the light incident plane angle.

3. The electronic device according to claim 1, wherein the light sources are mounted on a single board.

4. The electronic device according to claim 1, wherein the light axes are directed in a vertical direction.

5. The electronic device according to claim 1, wherein the light sources are surface emitting light emitting diodes.

6. The electronic device according to claim 1, wherein the light guide plates comprises polycarbonate.

7. The electronic device according to claim 1, wherein the light emitting parts are arranged along an edge of the housing, the edge defining a border between a front face of the housing and a top face of the housing, the front face being provided with a projection lens.

8. The electronic device according to claim 7, wherein the light emitting parts extend across both sides of the edge so as to face the front face and the top face.

9. The electronic device according to claim 7, wherein the light emitting parts are provided at locations different from each other in a vertical direction and/or in a depth direction of the housing.

10. A method of guiding light in an electronic device comprising:
emitting light from each of a plurality of light sources along a light axis, the light sources being provided within a housing; and
causing the lights emitted from the light sources to be incident on light incident planes of a plurality of light guide plates provided within the housing, guiding the lights within the light guide plates and causing the lights to be emitted from light emitting parts that are exposed at an outer surface of the housing,
wherein the lights emitted from the light sources are incident such that one of the light guide plates has a light incident plane angle that is different from a light incident plane angle of another light guide plate so that light axes of lights that are guided within the light guide plates pass through the light emitting parts, wherein the light incident plane angle is an acute angle that is formed between a normal line of the light incident plane and a light axis of the light that is incident on the light incident plane.
